(19) United States
(12) Patent Application Publication
(10) Pub. No.: US 2003/0172228 A1
(43) Pub. Date: Sep. 11, 2003

(54) Method and system for extending a hardfile partition table

(75) Inventors: Simon Chu, Chapel Hill, NC (US); Richard Alan Dayan, Wake Forest, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/093,261

(22) Filed: Mar. 7, 2002

(51) Int. Cl. G06F 12/00

(52) U.S. Cl. 711/112; 711/173; 713/1

(57) ABSTRACT

A method and system for extending a hardfile partition table in a computer system is disclosed. The computer system includes a hardfile, a master boot record and an operating system. The method and system include allowing a user to define a plurality of partitions on the hardfile using a utility and providing an extended physical partition table describing the plurality of partitions. The method and system also include mapping a portion of the plurality of partitions to a master boot record transparently to the operating system.

### FIELD OF THE INVENTION

The present invention relates to computer systems, and more particularly to a method and system for extending the partition table for a hardfile.

### BACKGROUND OF THE INVENTION

FIG. 1 depicts a conventional computer system 10. The conventional computer system 10 includes an operating system 12, a hardfile adapter 14 and a hardfile 20. The hardfile 20 includes partitions 22, 24, 26 and 28, a master boot record 30 and a legacy partition table 32 within the master boot record 30. Each partition 22, 24, 26 and 28 is thus a logical partition of the hardfile 20. Each of the partitions 22, 24, 26 and 28 can be a boot source. The legacy partition table 32 includes information relating to the partitions 22, 24, 26 and 28, including which partition is to be active for booting.

Although the conventional computer system 10 functions, one of ordinary skill in the art will readily recognize that there are drawbacks. In particular, only four partitions 22, 24, 26 and 28 are typically available. This is because the legacy partition table 32 is typically capable of storing data for no more than four partitions. Furthermore, a manufacturer may reserve one of the partitions 22, 24, 26 or 28 for the system's use. As a result, only three partitions would be available for a user. Although extensible firmware initiative (“EFI”) allows more partitions to be available on Intel Architecture (“IA”) 64-bit systems, such a solution is not currently workable for other systems including IA 32-bit systems. As a result, even for current large capacity systems, only four partitions are typically available. Furthermore, although certain conventional systems allow more partitions to be available, there is no indication that the provision of the additional partitions is visible to the operating system 12. In other words, the user must perform an additional task in order to make the operating system 12 recognize the additional partitions. In addition, the user may also have to take other actions, such as setting a flag in the master boot record 30, in order to access the additional partitions.

Accordingly, what is needed is a system and method for easily and seamlessly providing additional partitions in a computer system. The present invention addresses such a need.

### SUMMARY OF THE INVENTION

The present invention provides a method and system for extending a hardfile partition table in a computer system. The computer system includes a hardfile, a hardfile adapter, a master boot record and an operating system. The method and system comprise allowing a user to define a plurality of partitions on the hardfile using a utility and providing an extended physical partition table describing the plurality of partitions. The method and system also comprise mapping a portion of the plurality of partitions to a master boot record transparently to the operating system.

According to the system and method disclosed herein, the present invention provides a mechanism for defining and utilizing partitions in the computer system.

### BRIEF DESCRIPTION OF THE DRAWINGS

FIG. 1 is a block diagram of a conventional computer system.

FIG. 2A is a block diagram depicting one embodiment of a computer system in accordance with the present invention that provides partitions in a manner that is transparent to the operating system.

FIG. 2B is a block diagram depicting one embodiment of an extended physical partition table.

FIG. 3 is a block diagram depicting a second embodiment of a computer system in accordance with the present invention that provides partitions in a manner that is transparent to the operating system.

FIG. 4 is a high-level flow chart depicting one embodiment of a method in accordance with the present invention for providing partitions in a manner that is transparent to the operating system.

FIG. 5 is a high-level flow chart depicting one embodiment of a method in accordance with the present invention for mapping a portion of the plurality of partitions in a manner that is transparent to the operating system.

FIG. 6A depicts a high-level flow chart depicting one embodiment of a method in accordance with the present invention for associating a plurality of users with the partitions.

FIG. 6B depicts a high level flow chart of one embodiment of a method in accordance with the present invention for allowing a user to access a portion of the plurality of partitions.

FIGS. 7A and 7B a more detailed flow chart of a preferred embodiment of a method in accordance with the present invention for providing partitions in a manner that is transparent to the operating system.

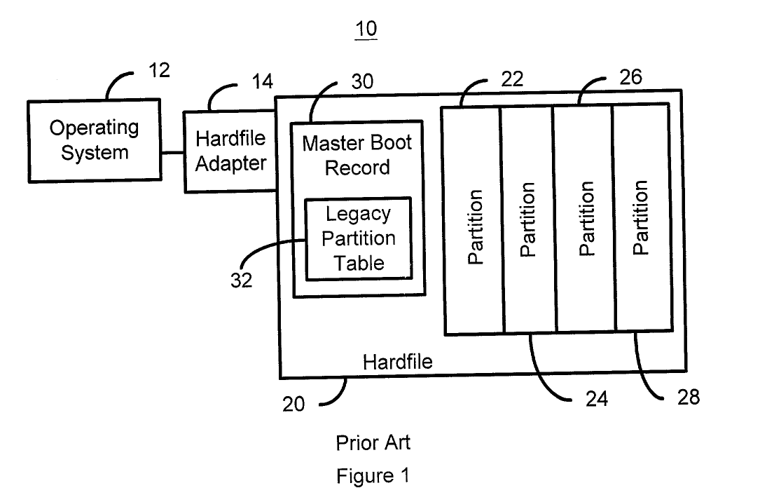

### DETAILED DESCRIPTION OF THE INVENTION

The present invention relates to an improvement in computer systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for extending a hardfile partition table in a computer system. The computer system includes a hardfile, a hardfile adapter, a master boot record and an operating system. The method and system comprise allowing a user to define a plurality of partitions on the hardfile using a utility and providing an extended physical partition table describing the plurality of partitions. The method and system also comprise mapping a portion of the plurality of partitions to a master boot record transparently to the operating system.

The method and system in accordance with the present invention is described in the context of a particular computers system having certain components. However, one of ordinary skill in the art will readily recognize that the present invention is consistent with other computer systems utilizing other components.

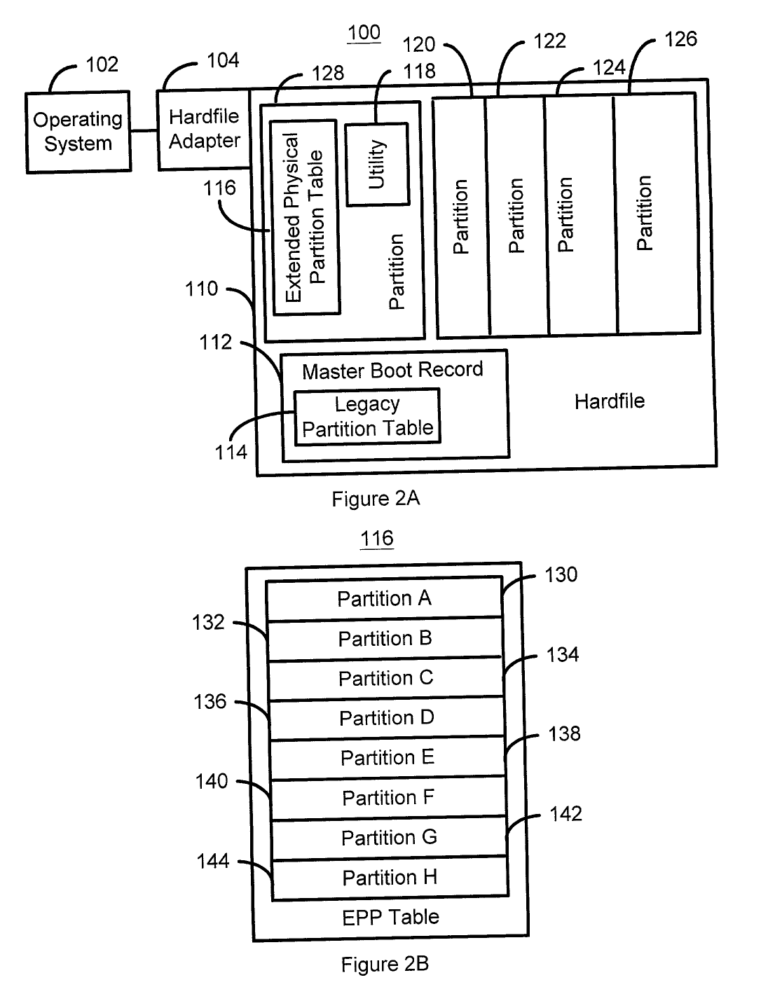

To more particularly describe the present invention, refer to FIG. 2A, which is a block diagram depicting one embodiment of a computer system 100 in accordance with the present invention that provides partitions and maps a portion of the partitions to a master boot record in a manner that is transparent to the operating system. The computer system 100 includes an operating system 102, a hardfile adapter 104 and a hardfile 110. The hardfile 110 includes a master boot record 112, a legacy partition table 114, an extended physical partition (EPP) table 116, a utility 118 and partitions 120, 122, 124, 126, and 128. Although five partitions 120, 122, 124, 126 and 128 are shown, only four partitions 120, 122, 124 and 126 are visible to the user. The partition 128 is preferably hidden from the user and thus not mapped to the legacy partition table 114. A hidden partition refers to a portion of a disk that is typically created using the SETMAX command as defined in the ATA/ATAPI-4 (NCITS 314-1998). The system's firmware also needs to support the firmware (BIOS) interface for accessing an area of an ATA drive that is normally hidden via the SETMAX command. This firmware interface provides services that an operating system may use to access the hidden area. The firmware interface is typically referred to as Protected Area Run Time Interface Extension Services or simply PARTIES. T13 is a Technical Committee for the National Committee on Information Technology Standards (NCITS) and maintains and controls all specifications relating to devices supporting the AT Attachment (ATA) storage interface. NCITS can be reached at http:/www.ncits.org. The computer system 100 thus includes hardfile with an integrated controller supporting the ATA storage interface that includes a SETMAX command. The hardfile supports at least the specification level, ATA/ATAPI-4 (NCITS317-1998) which is owned by the INCITS T13 Technical committee. More information can be found at http:/www.ncits.org/ and http://www.t13.org/#Documents 2001. Furthermore, although the EPP table 116 and utility 118 are shown in a single partition 128, nothing prevents the EPP table 116 and utility 118 from being in different partitions.

FIG. 2B depicts one embodiment of the EPP table 116. The EPP table 116 includes entries 130, 132, 134, 136, 138, 140, 142 and 144 for eight partitions A, B, C, D, E, F, G and H. Although entries 130, 132, 134, 136, 138, 140, 142 and 144 for eight partitions are shown, the EPP table 116 could include another number of entries. However, the EPP table 116 can include more than four entries. As a result, more than four partitions can be provided in the computer system 100. Referring to FIGS. 2A and 2B, the partitions 120, 122, 124 and 126 that are provided on the hardfile 110, are selected from the partitions having entries 130, 132, 134, 136, 138, 140, 142 and 144 in the EPP table 116. In a preferred embodiment, up to four partitions 120, 122, 124 and 126 are provided on the hardfile 110 and visible to a user at a particular time because the legacy partition table 114 can include a maximum of four entries. However, in an alternate embodiment, where the legacy partition table can include additional entries, more partitions could be provided on the hardfile 100.

Referring to FIGS. 2A and 2B, the utility 118, the EPP table 116 and the hardfile adapter 104 are used to provide the partitions 120, 122, 124 and 126 from the available partitions A, B, C, D, E, F, G and H transparently to the operating system 102. The number of available partitions provided in accordance with the present invention is given by the number of partitions in the EPP table and is thus greater than four. As described above, the EPP table 116 stores information relating to the partitions 120, 122, 124 and 126 as well as additional partitions (not shown) in the entries 130, 132, 134, 136, 138, 140, 142 and 144. The EPP table 116 thus preferably contains entries 130, 132, 134, 136, 138, 140, 142 and 144 for the partitions A, B, C, D, E, F, G and H. The partitions 120, 122, 124 and 126 are selected from the possible partitions A, B, C, D, E, F, G and H.

The entries 130, 132, 134, 136, 138, 140, 142 and 144 in the EPP table 116 describe the physical layout of the media for the hardfile 110 as well as the starting and ending points for each of the partitions A, B, C, D, E, F, G and H. In a preferred embodiment, the EPP table 116 uses an addressing scheme based upon head, cylinder and sector addresses provided by the hardfile adapter 104. Thus, the starting address is cylinder 0, head 0 and sector 1. However, in an alternate embodiment, another addressing scheme could be used. In a preferred embodiment, the EPP table 116 allows for any number of partitions up to the total number of physical sectors in the hardfile 110 reported by the hardfile adapter 104. Also in a preferred embodiment, each entry 130, 132, 134, 136, 138, 140, 142 or 144 in the EPP table 116 has the same format and data as an entry in the legacy partition table 114 to facilitate mapping of portions of the EPP table 116 to the legacy partition table 114. In a preferred embodiment, the EPP table 116 is stored on a partition 128 that is dedicated to the hardfile adapter 104 and which does not appear on a usable sector map provided to a user.

The utility 118 provides an interface that allows a user to define (initialize and change) the partitions A, B, C, D, E, F, G and H. For example, the user could set or alter the number of partitions or the size of one or more partitions using the utility 118. The utility 118 also allows the user to select which of the partitions A, B, C, D, E, F, G and H are the partitions 120, 122, 124 and 126 mapped to the legacy partition table 114 and to select which of the mapped partitions 120, 122, 124 or 126 is the active bootable partition. In a preferred embodiment, the partitions 120, 122, 124 and 126 mapped to the legacy partition table 114 are provided in an image. The image is then used for mapping to the legacy partition table 114. In one embodiment, the utility 118 also allows the user, such as a network administrator, to define images for different users. However, in an alternate embodiment, an additional utility (not shown) may be provided for this feature. In such an embodiment, an image for a particular user includes the partitions 120, 122, 124 and 126 that are accessible to the particular user. The utility 118 also allows the user to provide a password for each user and/or each image. Thus, the user(s) of a particular image will be required to enter the password before being allowed access to the partitions in the image. In a preferred embodiment, the partition 128 in which the utility 118 and EPP table 116 to be used by the network administrator are in a hidden partition 120 accessible only upon entry of the appropriate password.

The utility 118 also passes the data relating to the EPP table 116 to the hardfile adapter 104. The utility 118 also preferably builds the EPP table 116. In addition, the partitions 120, 122, 124 and 126 are mapped to the master boot record 112 transparently to the operating system. Thus, the operating system need not have any additional information relating to the partitions 120, 122, 124 and 126 and need not be aware of the existence of more than four partitions. In a preferred embodiment, the partitions 120, 122, 124 and 126 are consecutively mapped to make the partitions 120, 122, 124 and 126 transparent to the operating system 102. Consecutive mapping is carried out such that the portion of the partitions mapped to the master boot record 112 (i.e. the partitions 120, 122, 124, and 126) appear to the operating system to be sequential. Consecutive mapping is preferably carried out by mapping the partitions 120, 122, 124, and 126 to the legacy partition table 114 and providing a translation for the partitions 120, 122, 124, and 126 mapped to the legacy partition table 114. Preferably, consecutive mapping is carried out using the utility 118 and the hardfile adapter 102. The utility 118 maps at least a portion of the EPP table 116 to the legacy partition table 114 in the master boot record 112. The translation is preferably provided by the hardfile adapter 104. The translation makes it appear to the operating system 102 that the partitions 120, 122, 124 and 126 are consecutive and contiguous. In other words, the partitions 120, 122, 124 and 126 are mapped to the legacy partition table 114 such that the partitions 120, 122, 124 and 126 appear to the operating system 102 to be sequential. As a result, the mapping of the partitions 120, 122, 124 and 126 is transparent to the operating system 102. In addition, the portion of the partitions A, B, C, D, E, F, G and H in the EPP table 116 mapped to the legacy partition table 114 preferably includes no more than four partitions 120, 122, 124 and 126.

For example, suppose that the hardfile 110 has a forty GByte capacity and that the entries 130, 132, 134, 136, 138, 140, 142 and 144 in the EPP table 116 describe eight partitions as follows (using sectors for addressing rather than the preferred cylinder, head and sector address): Partition A: 0-1,999,999 sectors; Partition B: 2,000,000-9,999,999 sectors; Partition C: 10,000,000-15,999,999 sectors; Partition D: 16,000,000-29,999,999 sectors; Partition E: 30,000,000-39,999,999 sectors; Partition F: 40,000,000-49,999,999 sectors; Partition E: 50,000,000-59,999,999 sectors; Partition H: 60,000,000-78,124,999 sectors. Suppose also that a user has selected Partitions A, E, H and B to be mapped to the legacy partition table 114. In other words, the user has defined an image including Partitions A, E, H and B. The utility 118 maps sectors A, E, H and B to the legacy partition table 114. The utility 118 also provides information relating to the partitions A, E, H and B to the hardfile adapter 104, which creates a translation for these partitions. The translation preferably takes the form of a translation table. The translation translates the addresses of the partitions A, E, H and B such that the partitions A, E, H and B appear to have sequential address. Thus, the partitions A, E, H and B appear to the operating system 102 to have the following map: Legacy Partition 1 (Partition A): 0-1,999,999 sectors; Legacy Partition 2 (Partition E): 2,000,000-11,999,999 sectors; Legacy Partition 3 (Partition H): 12,000,000-30,124,999 sectors; Legacy Partition 4 (Partition B): 30,125,000-38,124,999 sectors.

Thus, a portion of the partitions is consecutively mapped to the legacy partition table 114. Each of the partitions has the appropriate size as mapped to the legacy partition table 114. The partitions mapped to the legacy partition table 114 appear to the operating system 102 as consecutive and as though these are the only partitions on the hardfile 110 even though the partitions may not be consecutive and may be only a portion of the partitions that could be provided on the hardfile 110. The fact that there are additional partitions (Partitions C, D, F and G) and that the partitions are not actually consecutive is transparent to the operating system 102. Thus, the operating system need not have any additional information relating to the partitions 120, 122, 124 and 126 and need not be aware of the existence of more than four partitions mapped to the legacy partition table 114. Moreover, it is not required that the user perform any additional operations to provide the partitions 120, 122, 124 and 126. For example, no flag is required to be set in the master boot record 112.

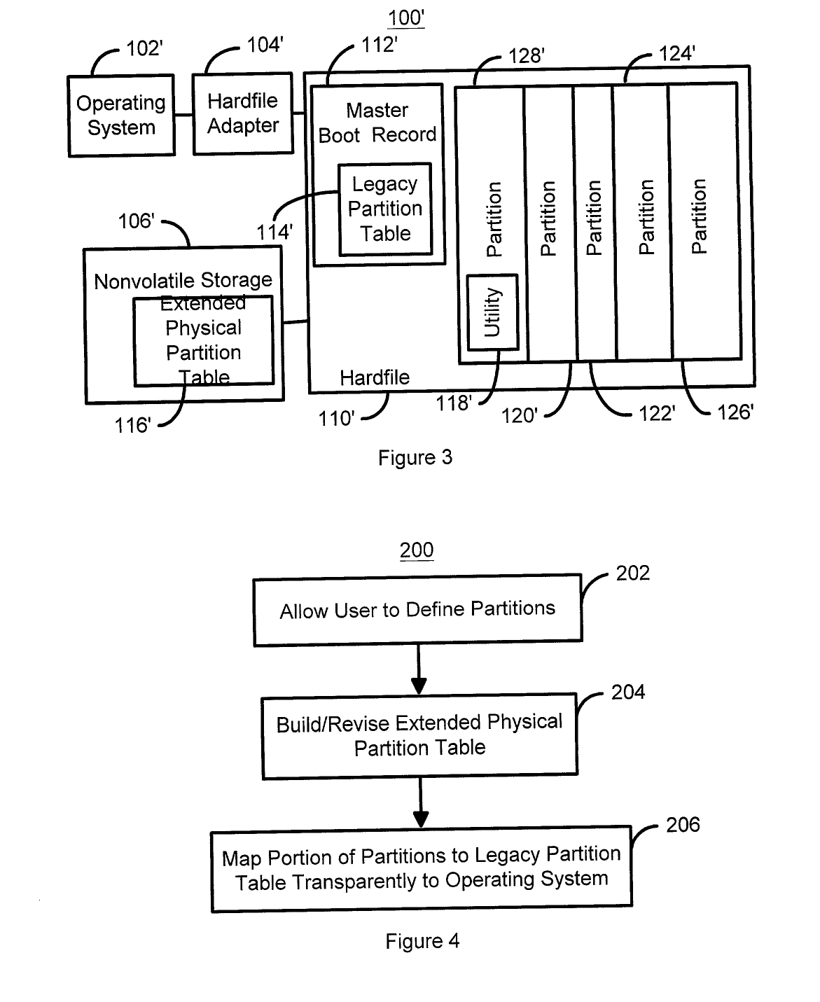

FIG. 3 is a block diagram depicting a second embodiment of a computer system 100′ in accordance with the present invention that provides partitions in a manner that is transparent to the operating system. The components of the computer system 100′ are analogous to the computer system 100 depicted in FIG. 2A. Thus, components of the computer system 100′ of FIG. 2B are numbered similarly to the components of the computer system 100 shown in FIG. 2A. Moreover, the EPP table 116′ may be as shown in FIG. 2B. However, the EPP table 116′ is stored on nonvolatile storage 106′ of the computer system 100′ rather than on the hardfile 110′. However, the computer system 100′ functions in a manner analogous to the computer system 100. Consequently, the computer system 100′ can also provide partitions A, B, C, D, E, F, G and H, as well as map the partitions 120′, 122′, 124′ and 126′ to the legacy partition table 114′ transparently to the operating system. The computer system 100′ also includes the hidden partition 128′ in which the utility 118′ is located.

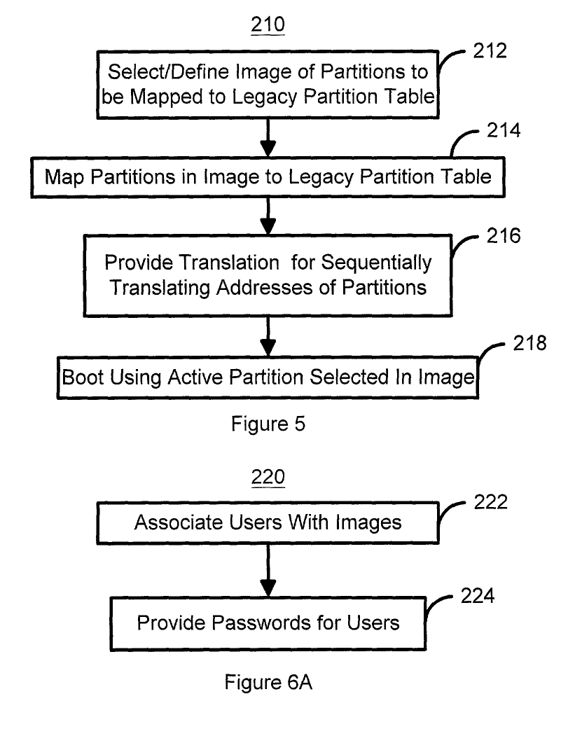

FIG. 4 is a high-level flow chart depicting one embodiment of a method 200 in accordance with the present invention for providing partitions transparently to the operating system. The method 200 can be used by the computer system 100 and 100′. For clarity, the method 200 is described in conjunction with the computer system 100. The method 200 preferably commences after the computer system 100 has been booted up. In a preferred embodiment, the computer system 100 is powered on, the utility 118 booted up prior to the method 200 starting. Also in a preferred embodiment, a user may be required to enter a password before being allowed to perform the functions in the method 200.

The user is allowed to define the partitions A, B, C, D, E, F, G and H, via step 202. Step 202 is preferably performed by using the utility to provide a graphical user interface. From the graphical user interface, the user can perform many operations relating to the partitions A, B, C, D, E, F, G and H. In step 202 the user is allowed to define the partitions A, B, C, D, E, F, G and H. Defining the partitions preferably includes initializing the partitions A, B, C, D, E, F, G and H to set the initial number and size of the partitions A, B, C, D, E, F, G and H as well as changing the size and number of partitions previously defined.

The EPP table 116 is then built or revised based upon the information provided by the user, via step 204. In a preferred embodiment, step 204 is performed by the utility 118. The utility also passes the information received from the user, such as the number of partitions and size of each partition, to the hardfile adapter 104. The utility 118 thus builds or revises the EPP table 116, preferably using new commands tailored to providing the partitions A, B, C, D, E, F, G and H.

At least a portion of the EPP table 116 is mapped to the legacy partition table 114 in a manner that is transparent to the operating system 102, via step 206. Thus, the partitions 120, 122, 124 and 126 are selected from the available partitions A, B, C, D, E, F, G and H. Step 206 also indicates which of the partitions 120, 122, 124 and 126 mapped to the legacy partition table 114 is to be active. Because the master boot record 112, which is a conventional master boot record, only recognizes up to four partitions, step 206 preferably maps up to four partitions 120, 122, 124 and 126 to the legacy partition table 114. Also in a preferred embodiment, the mapping is consecutive, as described above. This consecutive mapping of the portion of the partitions 120, 122, 124 and 126 allows the partitions 120, 122, 124 and 126 to be used without requiring additional information to be provided to the operating system 102.

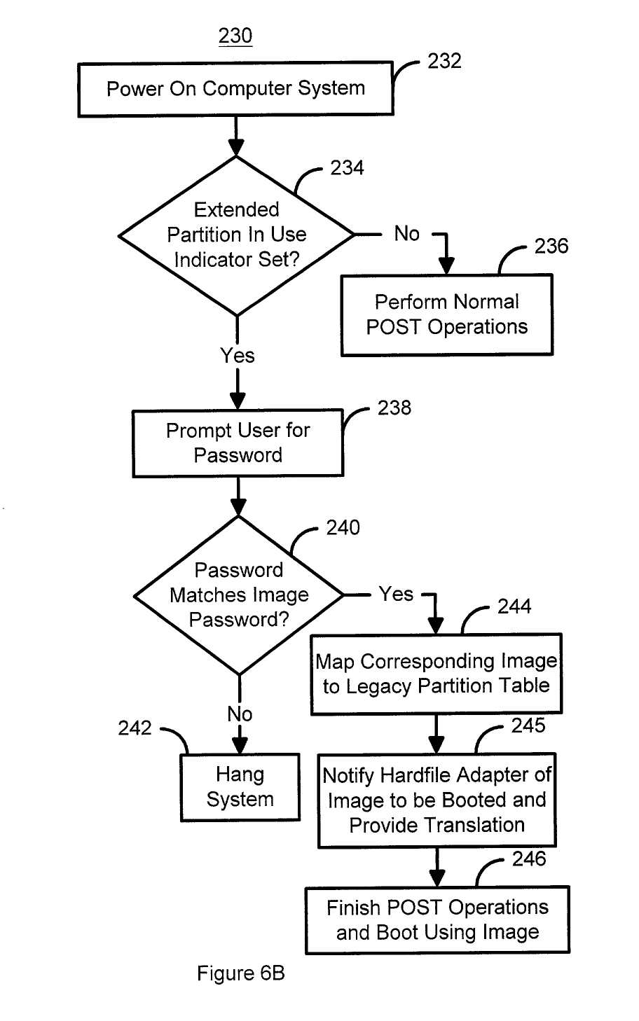

FIG. 5 is a high-level flow chart depicting one embodiment of a method 210 in accordance with the present invention for mapping a portion of the plurality of partitions in a manner that is transparent to the operating system. The method 210 can be used by the computer system 100 and 100′. For clarity, the method 210 is described in conjunction with the computer system 100. In addition, the method 210 is preferably used for the step 206 of the method 200.

The image of the partitions 120, 122, 124 and 126 to be mapped to the legacy partition table 114 is selected and/or prepared by the user, via step 212. Step 212 can include any combination of providing an image by identifying the partitions to be mapped to the legacy partition table 114; changing the number, size or identity of the partitions that are part of the image; identifying an image that was previously prepared as being the image to be mapped to the legacy partition table or changing the partition in the image that is to be the bootable partition. The data from the EPP table 116 is then used by the utility 118 to map the partitions 120, 122, 124, and 126 in the image to the legacy partition table 114, via step 214. In a preferred embodiment, the image provided in step 212 is stored in a location that is accessible upon start up of the computer system 100. In a preferred embodiment, therefore, step 214 is performed upon start up of the computer system. Also in a preferred embodiment, step 214 also includes requiring a user to enter a password to select the particular image mapped to the legacy partition table 114. The hardfile adapter 104 is used to provide a translation, preferably in the form of a translation table, via step 216. The translation table sequentially translates the addresses of the partitions 120, 122, 124 and 126 mapped to the legacy partition table 114. As a result, steps 214 and 216 consecutively map the partitions in the image to the legacy partition table 114, allowing the partitions 120, 122, 124 and 126 to appear sequential to the operating system 102. In other words, the partitions 120, 122, 124 and 126 are consecutively mapped, as described above, so that partitions 120, 122, 124 and 126 in the image that may not be physically adjacent are seen as being adjacent by the operating system 102. The computer system 100 boots off of the appropriate active partition 120, 122, 124 or 126 that has been mapped to the legacy partition table 114, via step 218. Consequently, a portion of the partitions can be provided to the legacy partition table 114 and made accessible in a manner that is transparent to the operating system.

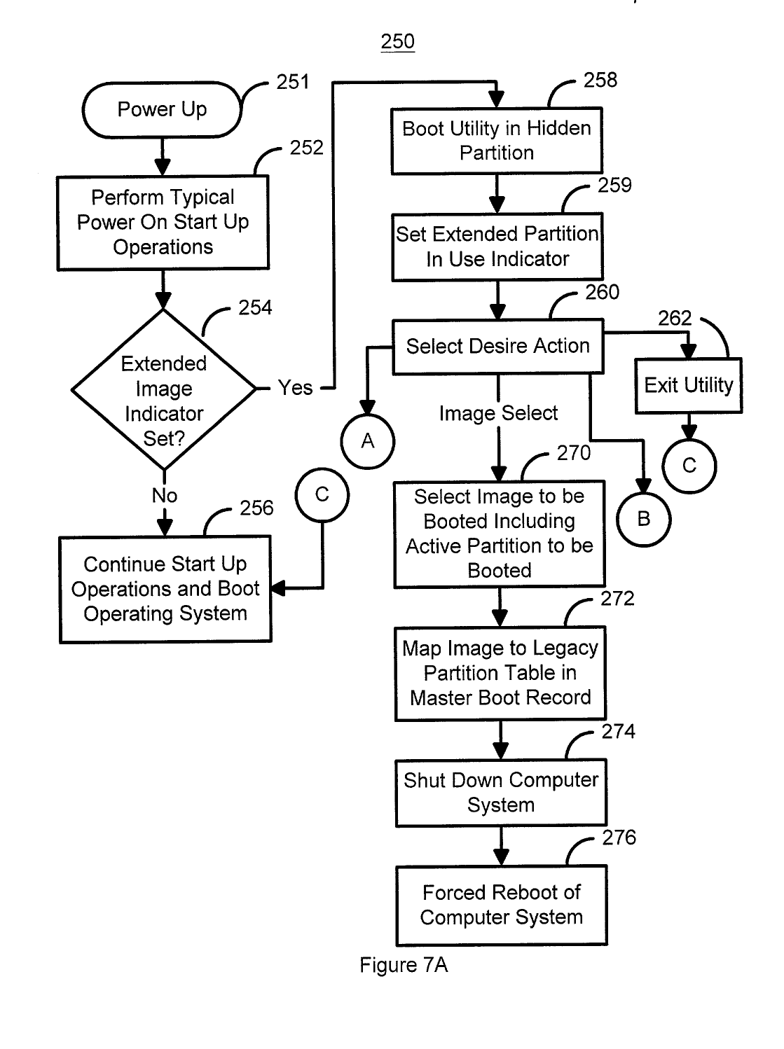

FIG. 6A depicts a high-level flow chart depicting one embodiment of a method 220 in accordance with the present invention for associating a plurality of users with the partitions. The method 220 can be used by the computer system 100 and 100′. For clarity, the method 220 is described in conjunction with the computer system 100. The method 220 is preferably carried out by a system administrator or similarly situated user of the computer system 100. In addition, the partition 128 including the utility 118 and the EPP table 116 is preferably hidden from most users of the system and accessible only through entry of the system administrator's password. Consequently, only the system administrator would be capable of performing the method 220 to set the portion of the partitions 120, 122, 124 and 126 which the user is allowed to access.

The users of the computer system 100 are associated with images, via step 222. In step 222, a user of the computer system is given an image including the portion of the partitions 120, 122, 124 and 126 to be mapped to the legacy partition table 114. The image indicates the portion of the partitions 120, 122, 124 and 126 the user has access to and which of the partitions 120, 122, 124 or 126 the computer system 100 will boot from for the user. Thus, the image preferably includes certain entries 130, 132, 134, 136, 138, 140, 142 and 144 of the EPP table 116. The user is also provided with a password, via step 224. In a preferred embodiment, the password is required to be entered by the user for the user to access the partitions 120, 122, 124 and 126 in the image. In one embodiment, steps 222 and 224 include building or revising an additional table of images and user passwords (not shown).

FIG. 6B depicts a high level flow chart of one embodiment of a method 230 in accordance with the present invention for allowing a user to access a portion of the plurality of partitions. The method 230 can be used by the computer system 100 and 100′. For clarity, the method 230 is described in conjunction with the computer system 100.

The computer system 100 is powered on, via step 232. It is determined whether the extended partition in use indicator is set via step 234. Step 234 thus determines whether the extended partition table 116, and thus some portion of the partitions A, B, C, D, E, F, G, and H, is to be accessible. If it is determined that the extended partition in use indicator is not set, then the computer system 100 performs normal power on self test (“POST”) operations, via step 236.

If the extended partition in use indicator is set, then the user is prompted for a password, via step 238. Step 238 also preferably includes allowing a user to enter the password for which he was prompted. It is determined whether the password matches a password for one of the images in the computer system, via step 240. The images and passwords are those images associated with the users in the method 220 depicted in FIG. 6A. Referring back to FIG. 6B, if a matching password is not entered, then the system is hung up, via step 242. In one embodiment, the user may be given multiple opportunities to enter a matching password in steps 238 and 242 before the computer system 100 is hung up in step 242.

If the password entered by the user matches a password for one of the images, then the corresponding image is mapped to the legacy partition table, via step 244. Via step 245, the hardfile adapter 104 is notified of the image about to be booted so that it may provide a translation for sequentially translating address of partitions in a similar manner to step 216 of the method 200. POST operations are then completed and the computer system 100 is booted using the (new) partitions in the legacy partition table 114, via step 246. Thus, each user is allowed to access only certain partitions in the computer system 100. These accessible partitions are the partitions in the image mapped to the legacy partition table 114. As a result, the computer system 100 can support multiple users while maintaining the security of the computer system 100, as well as individual users, by restricting the partitions 120, 122, 124, and 126 to which a user has access.

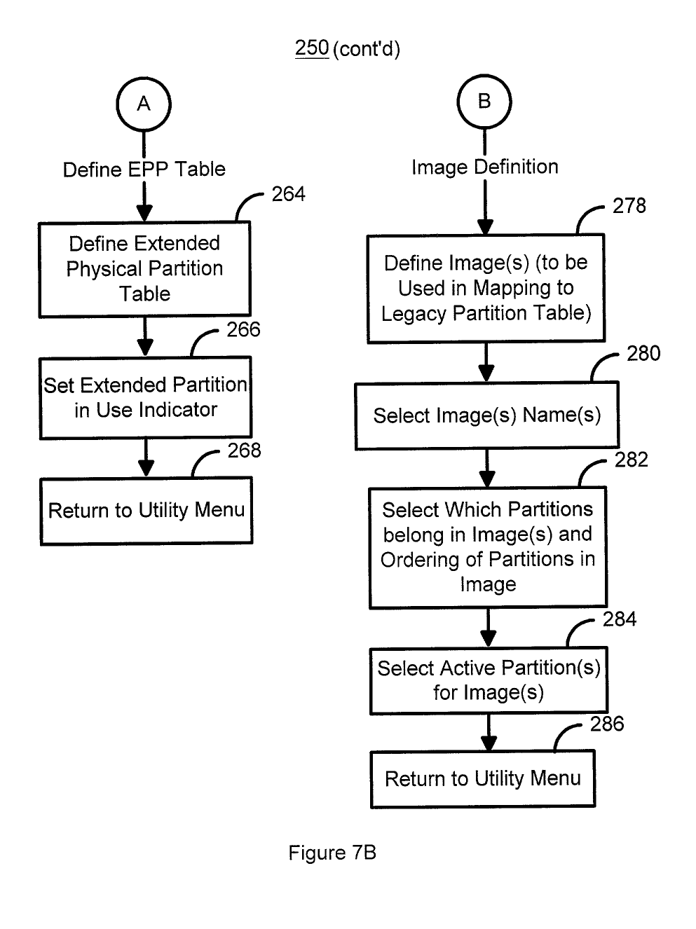

FIGS. 7A and 7B depict a more detailed flow chart of a preferred embodiment of a method 250 in accordance with the present invention. The method 250 can be used by the computer system 100 and 100′. For clarity, the method 250 is described in conjunction with the computer system 100.

The computer system 100 is powered up, via step 251. The typical operations performed after power on are carried out using POST, via step 252. It is determined whether an extended image indicator is set using POST, via step 254. The indicator informs the computer system 100 that the hardfile adapter 104, the EPP table 116 and the utility 118 are used to provide additional partitions. The extended image indicator could be set using a separate utility (not shown) or using an additional step in the method 250. When the extended image indicator is set in the method 250 or using the separate utility, the next time the computer system 100 is booted, the utility 118 is booted in step 258, discussed below. If it is determined that the indicator is not set, then the normal power on operations are continued and the operating system 100 is booted, via step 256.

If the indicator is set, then the utility 118 is booted, via step 258. The user is then prompted to select the desired action, via step 260. Step 260 preferably includes providing the user with a graphical user interface depicting the user's options. In the embodiment shown, the user's options include defining the EPP table 116, selecting an image to be mapped to the legacy partition table 114, defining an image or exiting the utility 118. Other and/or additional options could also be provided. If the user selects to exit the utility, then the utility is exited in step 262. Step 256 is then returned to and the operating system booted using the current contents of the legacy partition table 114.

If the user selects to define the EPP table, then the EPP table is defined, via step 264. Step 264 preferably includes allowing the user to define the partitions A, B, C, D, E, F, G and H and the EPP table 116 is built using the utility 118. Preferably step 264 is carried out as described above in the methods 200, 210 and 220 of FIGS. 4, 5 and 6, respectively. Referring back to FIGS. 7A and 7B, the extended partition in use indicator is set, via step 266. Thus, the computer system 100 is informed that additional partitions may be provided through the hardfile adapter 104, the EPP table 116 and the utility 118. The menu of the utility provided in step 260 is returned to, via step 268.

If the user desires to select the image to be mapped to the legacy partition table 114 and, therefore, booted, then step 270 is performed. Thus, the user is allowed to select an image to be booted including the active partition to be booted, via step 270. The image preferably includes no more than four partitions 120, 122, 124 and 126 because the legacy partition table 114 is capable of storing information relating to only four partitions. The image is consecutively mapped to the legacy partition table, via step 272. Thus, step 272 could be seen as writing a new partition table, which replaces the old legacy partition table 114, to the master boot record 112. The consecutive mapping preferably includes mapping to the legacy partition table 114 and providing a translation and is preferably carried out using the utility 118 and the hardfile adapter 104 as described above with respect to FIG. 5. The computer system 100 is shut down, via step 274. A forced reboot of the computer system 100 performed, via step 276. Thus, the computer system 100 will reboot using the portion of the partitions 120, 122, 124 and 126 that have been mapped to the legacy partition table 114.

If the user desires to define the image to be mapped to the legacy partition table 114, then step 278 is performed. Thus, the image to be mapped to the legacy partition table 114 is defined, via step 278. A name is chosen for the image, via step 280. The portion of the partitions A, B, C, D, E, F, G and H in the EPP table 116 that are to be in the image are then selected, via step 282. Step 282 also includes selecting the order of the partitions 120, 122, 124 and 126 within the image. The partition 120, 122, 124 or 126 of the image that is to be used as the active partition is chosen, via step 284. Thus, the definition of the image is complete and the menu of the utility 118 is returned to, via step 286.

Thus a user is allowed to define the EPP table 116 and set the partitions 120, 122, 124 and 126 to be mapped to the legacy partition table 114. The EPP table 116 allows additional partitions A, B, C, D, E, F, G and H to be provided in the computer system 100. In addition, the partitions 120, 122, 124 and 126 are mapped to the legacy partition table 114 transparently to the operating system 102. Moreover, users can be associated with different images to allow different users access to different portions of the computer system 100.

A method and system has been disclosed for providing partitions in a computer system transparently to the operating system. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for extending a hardfile partition table in a computer system, the computer system including a hardfile, a master boot record and an operating system, the method comprising the steps of:
(a) allowing a user to define a plurality of partitions on the hardfile using a utility;
(b) providing an extended physical partition table describing the plurality of partitions; and
(c) mapping a portion of the plurality of partitions to a master boot record transparently to the operating system.

2. The method of claim 1 wherein the computer system further includes a hardfile adapter and a legacy partition table and wherein the mapping step (c) further includes the step of:
(c1) mapping the portion of the plurality of partitions to the legacy partition table; and
(c2) providing a translation for the portion of the plurality of partitions, the translation for sequentially translating the portion of the plurality of partitions, the translation being provided using the hardfile adapter.

3. The method of claim 1 wherein the step of allowing the user to define the plurality of partitions further includes the step of:
(a1) allowing the user to initialize the plurality of partitions on the hardfile using the utility.

4. The method of claim 1 wherein the step of allowing the user to define the plurality of partitions further includes the step of:
(a1) allowing the user to redefine the plurality of partitions on the hardfile using the utility.

5. The method of claim 1 further comprising the step of:
(d) allowing the user to define a size for each of the plurality of partitions.

6. The method of claim 1 wherein the extended physical partition table is stored on nonvolatile memory of the computer system.

7. The method of claim 1 wherein the extended physical partition table is stored on a partition of the plurality of partitions.

8 . The method of claim 1 further comprising the step of:
(d) allowing the user to select a partition of the plurality of partitions as a bootable partition.

9. The method of claim 1 wherein a plurality of users are associated with the computer system and wherein the method further includes the step of:
(d) providing a plurality of images, each of the plurality of images including at least a portion of the plurality of partitions and being associated with at least one user of the plurality of users.

10. The method of claim 9 wherein each of the plurality of images is associated with a password, the password being required to access a corresponding image of the plurality of images.

11. A computer system including a hardfile, a hardfile adapter, a master boot record and an operating system, the computer system comprising:
an extended physical partition table describing a plurality of partitions on the hardfile;
a utility for allowing a user to define the plurality of partitions on the hardfile and passing data relating to a portion of the plurality of partitions to the hardfile adapter, the utility mapping a portion of the plurality of partitions to a master boot record transparently to the operating system.

12. The computer system of claim 11 wherein the computer system further includes a legacy partition table, wherein the utility maps the portion of the plurality of partitions to the legacy boot record and wherein the hardfile adapter provides a translation for the portion of the plurality of partitions, the translation for sequentially translating the portion of the plurality of partitions.

13. The computer system of claim 11 wherein the utility further allows the user to initialize the plurality of partitions on the hardfile.

14. The computer system of claim 11 wherein the utility further allows the user to redefine the plurality of partitions on the hardfile.

15. The computer system of claim 11 wherein the plurality of partitions are capable of including more than four partitions.

16. The computer system of claim 11 wherein the utility further allows the user to define a size for each of the plurality of partitions.

17. The computer system of claim 11 further comprising a nonvolatile memory and wherein the extended physical partition table is stored on the nonvolatile memory.

18. The computer system of claim 11 wherein the extended physical partition table is stored on a partition of the plurality of partitions.

19. The computer system of claim 1 wherein the utility further allows the user to select a partition of the plurality of partitions as a bootable partition.

20. The computer system of claim 11 wherein a plurality of users are associated with the computer system and wherein the utility further provides a plurality of images, each of the plurality of images including at least a portion of the plurality of partitions and being associated with at least one user of the plurality of users.

21. The computer system of claim 20 wherein each of the plurality of images is associated with a password, the password being required to access a corresponding image of the plurality of images.
